(19) United States
(12) Patent Application Publication
(10) Pub. No.: US 2025/0271889 A1
(43) Pub. Date: Aug. 28, 2025

(54) Leakage Insensitive Switch Control for Bandgap Thermal Sensors in Core-MOS Nodes

(71) Applicant: Taiwan Semiconductor Manufacturing Company, Ltd., Hsinchu (TW)

(72) Inventors: Szu-Lin Liu, Hsinchu (TW); Yi Chen Lu, Hsinchu (TW); Bei-Shing Lien, Hsinchu (TW)

(21) Appl. No.: 18/585,179

(22) Filed: Feb. 23, 2024

(51) Int. Cl. G05F 3/26; G01K 7/01

(52) U.S. Cl. CPC G05F 3/262; G01K 7/01

(57) ABSTRACT

Systems and methods are provided for a circuit comprising an operating voltage node, a current mirror circuit, and a dynamic element matching (DEM) circuit. The current mirror circuit is coupled to the operating voltage node and comprises a plurality of resistive devices. The current mirror circuit is configured to generate a bias current over the plurality of resistive devices. The DEM circuit comprises a plurality of DEM transistors coupled to the current mirror circuit. The DEM circuit is configured to switch the bias current through one or more of the plurality of DEM transistors. The DEM circuit includes a leakage reduction circuit configured to reduce a gate current of the one or more of the plurality of DEM transistors and is configured to generate a DEM output current based on the bias current and the gate current.

### FIELD

The present disclosure relates to bandgap thermal sensors, and in particular to bandgap thermal sensors in core-MOS nodes.

### BACKGROUND

A bandgap thermal sensor is a temperature sensor used in electronic equipment. In some bandgap thermal sensors, chopper switches are used to improve signal quality within the bandgap thermal sensors. Some chopper switches utilize dynamic element matching (“DEM”) technology and are used in bandgap thermal sensors. Such devices can be susceptible to undesirable leakage currents.

### BRIEF DESCRIPTION OF THE DRAWINGS

The following detailed description will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1 depicts a block diagram of a bandgap thermal sensor, in accordance with some embodiments.

FIG. 2 depicts a detailed diagram of a current mirror circuit, a DEM circuit, and a cascode stage, in accordance with some embodiments.

FIG. 3 depicts a leakage reduction circuit 103 for one of the sets of resistive paths in accordance with an embodiment.

FIG. 4 a detailed diagram of a current mirror circuit, a DEM circuit, and a cascode stage, in accordance with some embodiments.

FIG. 5 depicts a block diagram of a bandgap thermal sensor with a leakage reduction chopper switch, in accordance with some embodiments.

FIG. 6 depicts a leakage reduction chopper switch, in accordance with some embodiments.

FIG. 7 depicts a leakage reduction switching element, in accordance with some embodiments.

FIG. 8 depicts a method of reducing gate leakage current, in accordance with some embodiments.

FIG. 9 depicts an alternative implementation of a leakage reduction circuit applied to the gate of a transistor on a resistive path of a DEM.

FIG. 10 depicts a second alternative implementation of a leakage reduction circuit applied to the drain/source of the transistor on a resistive path of a DEM.

FIG. 11 depicts a further example of the leakage reduction circuit of FIG. 10 in an implementation where no cascode stage is utilized.

FIG. 12 provides a further alternative for control of the gate of the first transistor between a current mirror transistor and a cascode transistor.

FIG. 13 provides an additional alternative for control of the gate of the first transistor between the current mirror transistor and the cascode transistor.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

As noted above, certain devices, such as BGT Bandgap/Thermal Sensor circuits may be susceptible to undesirable leakage currents, providing power inefficiencies. In some instances, core-MOS DEM chopper switches of BJT bandgap/thermal sensor (BG/TS) devices (e.g., 1.2V VDD devices) have evidenced undesirable gate leakages. Control of such leakages may be difficult in instances where a BJT BG/TS operates well with VDD>1V, which may be limited by P/N junction turn-on voltages and bias-current headroom in the VDD-minus-10% corner. Further, certain technologies such as Core-MOS may operate best with V_{gd}/V_{gs}/V_{ds} less than 1V for reliability considerations. DEM/chopper switches may be used in BJT BG/TS to reduce mismatch. However, reliability concerns may remain in certain instances, such as core-MOS-only technologies.

Systems and methods herein, in embodiments, provide designs that may operate in core-MOS-only technologies, such that node scaling is maintained. In embodiments, the temperature sensing device (BJT) and main circuit architectures can be implemented away from BG/TS architectures, which can reduce node-to-node design migration efforts. Systems and methods, in embodiments, are proposed to limit the impact of gate leak, which may be applicable to certain technologies such as a pure core-MOS DEM/chopper circuit in HV design, as well as others.

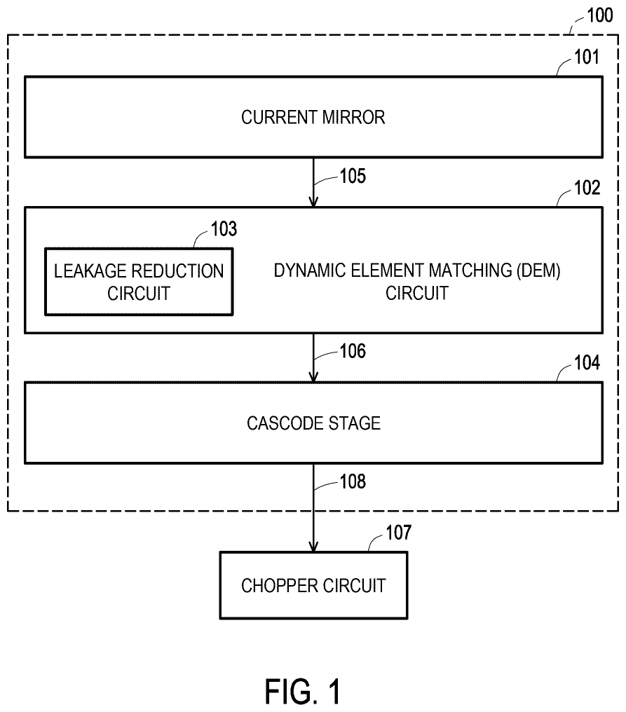

FIG. 1 depicts a block diagram of a bandgap thermal sensor, in accordance with some embodiments. The bandgap thermal sensor 100 is responsive to an operating voltage node (not shown) and produces a signal that is indicative of a temperature. In the example shown in FIG. 1, the bandgap thermal sensor 100 includes a current mirror circuit 101, a dynamic element matching (DEM) circuit 102, and a cascode stage 104 that provide an output to a chopper circuit 107 from which the temperature measurement can be ascertained.

The current mirror circuit 101 is coupled to the operating voltage node (not shown). The current mirror circuit 101 includes a plurality of current matching devices (e.g., transistors) 232, 234, 236, 238. The current mirror circuit 101 generates one or more bias currents 105, 244, 246, 248, one across each of the plurality of the current matching devices 232, 234, 236, 238.

The DEM circuit 102 is configured to selectively transfer each bias current 105 over one or more resistive devices (e.g., transistors) based on, for example, characteristics of the resistive devices or magnitude of the bias current 105. The DEM circuit 102 includes a leakage reduction circuit 103. The leakage reduction circuit 103 is coupled to the plurality of resistive devices and is configured to reduce an amount of leakage current flowing from the resistive devices to an external node (e.g., ground). The DEM circuit 102 generates a DEM output current 106.

The cascode stage 104 receives the DEM output current 106 at a plurality of resistive devices connected in parallel. The cascode stage 104 generates a cascode stage output current 108. The cascode stage output current 108 is received by the chopper circuit 107. The chopper circuit 107 is used to control an amount of current passing through a resistive element (e.g., a resistor). A temperature can be determined based on the current passing through the resistive element within the chopper circuit 107.

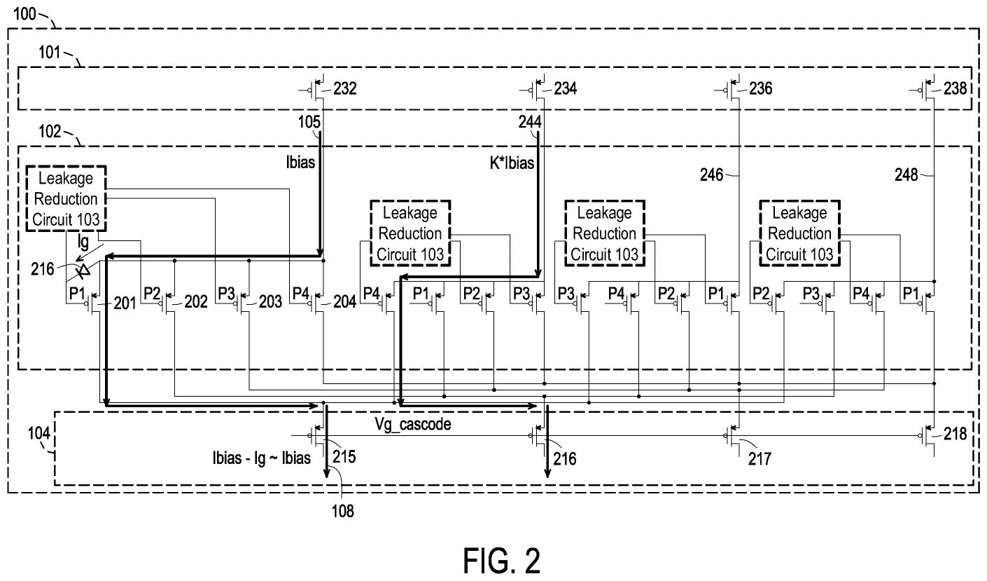

FIG. 2 depicts a diagram of a current mirror circuit, a DEM circuit, and a cascode stage, in accordance with some embodiments. In the example shown in FIG. 2, each of a plurality of current mirror current matching devices 232, 234, 236, 238 provides a bias current, 105, 244, 246, 248, respectively. In an embodiment, the bias currents 105, 244, 246, 248 are proportional to one another (e.g., the second bias current 244 is about K-times the magnitude of the first bias current 105). The bias currents 105, 244, 245, 246 are received by the DEM circuit 102. The DEM circuit 102 is configured to switch each bias current 105, 244, 245, 246 through one or more of a plurality of resistive paths. For example, for bias current 105, the DEM circuit 102 includes a resistive path including a first transistor 201, a resistive path including a second transistor 202, a resistive path including a third transistor 203, and a resistive path including a fourth transistor 204. In operation, one or more of those transistors 201, 202, 203, 204 may be selective as operative at a time. In embodiments, the resistive path selected by the DEM circuit 102 may be selected based on a digital control signal applied at the gates of those transistors 201, 202, 203, 204. In the example of FIG. 2, the resistive path transistors 201, 202, 203, 204 are active low transistors, where a ground signal applied at one of p1, p2, p3, p4 will activate the respective transistor 201, 202, 203, 204. In embodiments each of the resistive paths (16 resistive paths in FIG. 2) is independently controlled. In other examples, fewer signals are used. In the example of FIG. 2, four control signals (p1, p2, p3, p4) are utilized and provide control to four resistive path transistors each.

The cascode stage 104 includes a plurality of cascode transistors 215, 216, 217, 218 connected in parallel for each of the plurality of current branches. The input to those cascode transistors 215, 216, 217, 218 is dependent on which of the resistive path transistors (e.g., transistors 201, 202, 203, 204 in the first set of resistive paths) is active as commanded by its corresponding control signal. In the example of FIG. 2, the first cascode transistor 215 receives current from the first resistive path of each of the four sets, the second cascode transistor 266 receives current from the second resistive path of the four sets, the third cascode transistor 217 receives current from the third resistive path of the four sets, and the fourth cascode transistor 218 receives current from the fourth resistive path of the four sets.

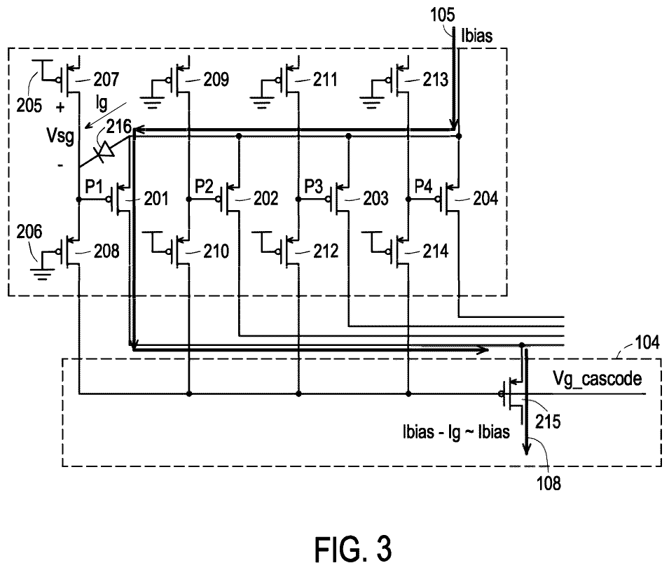

Each of the sets of resistive paths are responsive at the gates of their controlling transistors (e.g., at the gates of transistors 208, 210, 212, 214 in the first set of resistive paths) to a leakage reduction circuit 103, which facilitates control of signals p1, p2, p3, p4. FIG. 3 depicts a leakage reduction circuit 103 for one of the sets of resistive paths in accordance with an embodiment. In the example of FIG. 3, the leakage reduction circuit 103 provides two transistors responsive to the control nodes p1, p2, p3, p4. Specifically, the leakage reduction circuit 103 includes a first operating transistor 207 coupled to the first transistor 201 at p1 and a first ground transistor 208 coupled to the first transistor 201 at p1. Specifically, the first operating transistor 207 is a PMOS transistor that includes a gate terminal that is coupled to an operating voltage node 205 when the bias current 105 passes through the first transistor 201. The operating voltage node 205 may have a voltage of, for example, 1.2 V. The first operating transistor 207 further includes a source terminal that is coupled to a gate terminal of the first transistor. The first ground transistor 208 includes a gate terminal that is coupled to a ground voltage node 206 when the bias current 105 passes through the first transistor 201. The first ground transistor 208 further includes a drain terminal that is coupled to the gate terminal of the first transistor 201.

The leakage reduction circuit 103 further includes a second operating transistor 209, a third operating transistor 211, and a fourth operating transistor 213 that are responsive to control nodes p2, p3, and p4, respectively. Each of the second operating transistor 209, the third operating transistor 211, and the fourth operating transistor 213 include a source terminal that is coupled to a gate terminal of the second transistor 202, the third transistor 203, and the fourth transistor 204, respectively. The leakage reduction circuit 103 further includes a second ground transistor 210, a third ground transistor 212, and a fourth ground transistor 214, each responsive to control nodes p2, p3, and p4, respectively. Each of the second ground transistor 210, the third ground transistor 212, and the fourth ground transistor 214 include a drain terminal that is coupled to the gate terminal of the second transistor 202, the third transistor 203, and the fourth transistor 204, respectively.

In the example of FIG. 3, signal p1 is active, as indicated by the ground signal 206 at transistor 208, while signals p2, p3, p4 are inactive, as indicated by the high signals at the gates of transistors 210, 212, 214. This results in bias voltage 105 traversing the first transistor 201. When the bias current 105 passes over the first transistor 201, the leakage reduction circuit 103 thus forms a stacked-gate structure including the first transistor 201, the first ground transistor 208, and the cascode transistor 215 connected to the first transistor 201. The leakage reduction circuit thus reduces the gate-to-source voltage of the first transistor 201 when the bias current passes over the first transistor 201. Accordingly, the gate current 216 of the first transistor 201 is negligible, and substantially all of the bias current 105 delivered to the DEM circuit 102 is received by the cascode stage 104. In a similar way, the leakage reduction circuit 103 can reduce the gate-to-source voltage of the second transistor 202, the third transistor 203, or the fourth transistor 204 based on which of transistors 201, 202, 203, 304 over which the bias current 105 is flowing, as controlled by the signals applied to p1, p2, p3, p4 via transistors 208, 210, 212, 214.

Where the first transistor 201 is selected via an active p1 signal and the other transistors 202, 203, 204 are not, current 105 does not traverse those other transistors 202, 203, 204. When the bias current 105 is not passing over the second transistor 202, the gate terminal of the second operating transistor 209 is coupled to the ground voltage node 206 and the gate terminal of the second ground transistor 210 is coupled to the operating voltage node 205. Similarly, the gate terminals of the third operating transistor 211 and the fourth operating transistor 213 are coupled to the ground terminal node 206 when the bias current 105 is not passing through the third transistor 203 or the fourth transistor 204, and the gate terminals of the third ground transistor 212 and the fourth ground transistor 214 are coupled to the operating voltage node 205 when the bias current 105 is not passing through the third transistor 203 or the fourth transistor 204.

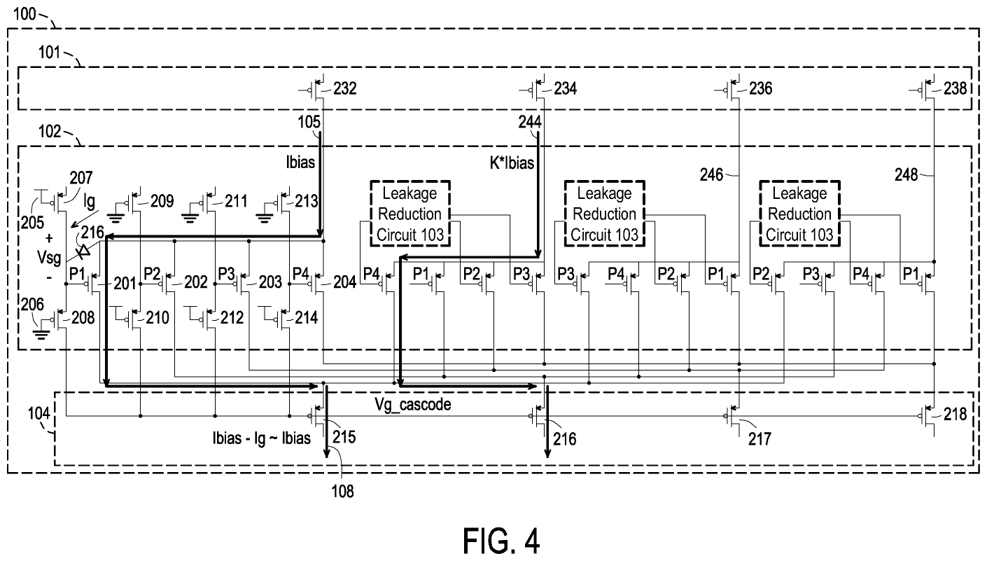

FIG. 4 a detailed diagram of a current mirror circuit, a DEM circuit, and a cascode stage, in accordance with some embodiments. In the example of FIG. 4, details of the leakage reduction circuit 103 associated with the first set of resistive paths associated with the first bias current 205 are shown in detail via transistors 207, 208, 209, 210, 211, 212, 213, and 214, their connection to respective ones of transistors 201, 202, 203, 204, and connections to the gates of the cascode transistors 215, 216, 217, 218. Details of the leakage reduction circuits 103 associated with the second, third, and fourth sets of resistive paths are presented in simplified states.

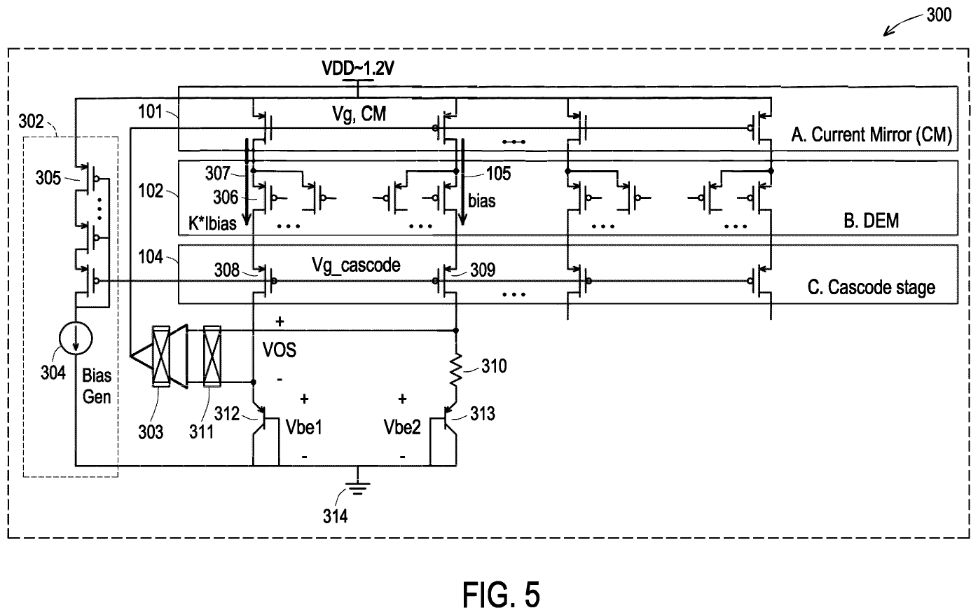

FIG. 5 depicts a block diagram of a bandgap thermal sensor with a leakage reduction chopper switch, in accordance with some embodiments. The bandgap thermal sensor 300 includes a current generator 302 including a current source 304 and a plurality of current generator transistors 305. There may be a constant number K of current generator transistors 305. The current source 304 generates the bias current 105, which is received by the current mirror circuit 101. The current mirror circuit 101 generates a DEM current 307 equal to the constant K times the bias current 105. The current mirror circuit 101 produces the bias current 105 across the remainder of a plurality of current mirror transistors. As described above, the DEM circuit 102 selectively switches the bias current 105 through one or more of a plurality of DEM transistors. The cascode stage 104 includes a plurality of cascode transistors connected in parallel. The cascode transistors include a first cascode transistor 308 that receives the DEM current 307 and a second cascode transistor 309 that receives the bias current 105.

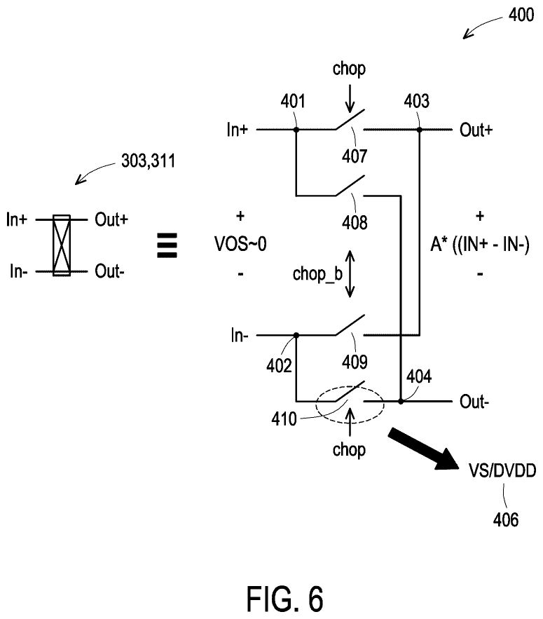

The first cascode transistor 308 is coupled to a first end of a first chopper switch 311 and the second cascode transistor 309 is coupled to a second end of the first chopper switch 311. An output of the first chopper switch 311 is coupled to a second chopper switch 303. The first cascode transistor is further coupled to a first temperature sensing transistor 312. The second cascode transistor 309 is further coupled to a first end of a resistor 310. A second end of the resistor 310 is coupled to a second temperature sensing transistor 313. The first temperature sensing transistor 312 and the second temperature sensing transistor 313 are coupled to a ground voltage node 314. The temperature of the bandgap thermal sensor 300 can be calculated based on comparing a voltage appearing across the first temperature sensing transistor 312 with a voltage appearing across the second temperature sensing transistor 313. The operation of the first chopper switch 311 and the second chopper switch 303 are described further in the description of FIG. 6.

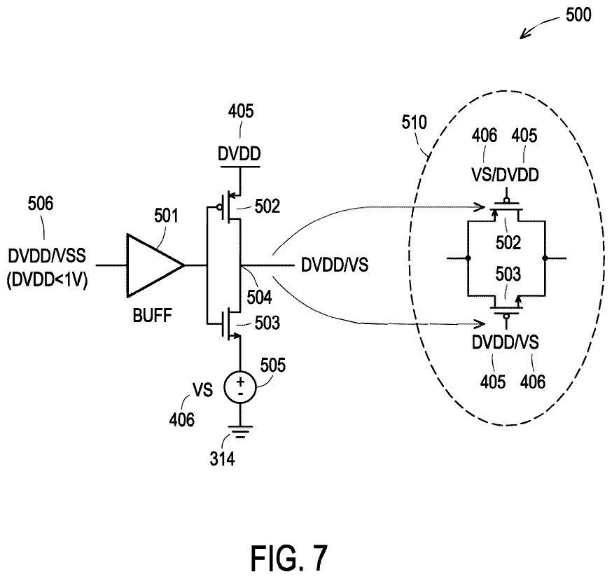

FIG. 6 depicts a leakage reduction chopper switch, in accordance with some embodiments. The leakage reduction chopper switch 400 may be, for example, the first chopper switch 311 or the second chopper switch 303 shown in FIG. 5. The leakage reduction chopper switch 400 includes a positive input voltage node 401, a negative input voltage node 402, a positive output voltage node 403, and a negative output voltage node 404. The leakage reduction chopper switch 400 further includes a first switching element 407, a second switching element 408, a third switching element 409, and a fourth switching element 410. The first switching element 407 is used to connect and disconnect the positive input voltage node 401 to the positive output voltage node 403. The second switching element 408 is used to connect and disconnect the positive input voltage node 401 to the negative output voltage node 404. The third switching element 409 is used to connect and disconnect the negative input voltage node 402 from the positive output voltage node 403. The fourth switching element 410 is used to connect and disconnect the negative input voltage node 402 from the negative output voltage node 404. Each of the switching elements 407, 408, 409, 410 is controlled by a digital operating voltage DVDD 405 and a source voltage VS 406. The operating of each of the switching elements 407, 408, 409, 410 is described further in the description of FIG. 7.

FIG. 7 illustrates a leakage reduction switching element, in accordance with some embodiments. The leakage reduction switching element 500 may be used as any of the switching elements 407, 408, 409, 410 in the leakage reduction chopper switch 400 shown in FIG. 6. In the example shown in FIG. 7, the leakage reduction switching element 500 includes a buffer 501. The buffer 501 receives a switching element input signal 506. The switching element input signal 506 may either be the digital operating voltage DVDD 405 or the source voltage VS 406. After passing through the buffer 501, the switching element input signal 506 is received at a gate terminal of a PMOS transistor 502 and a gate terminal of an NMOS transistor 503.

If the switching element input signal 506 is sufficiently high (e.g., the digital operating voltage DVDD 405), the NMOS transistor 503 is enabled and the ground voltage 314 (e.g., 0 volts) is coupled to a switching element output node 504, which can correspond, for example, to a switching element being closed. The leakage reduction switching element 500 includes a voltage source 505 that generates the source voltage VS 406 between the ground voltage node 314 and the NMOS transistor 503. If the switching element input signal 506 is sufficiently low (e.g., the source voltage VS 406), the PMOS transistor 502 is enabled and the digital operating voltage DVDD 405 is coupled to the switching element output node 504, which can correspond, for example, to a switching element being opened. Those signals are then applied as shown to one of the switching elements (e.g., switching element 410 of FIG. 6) so as to control that switch with minimized gate leak.

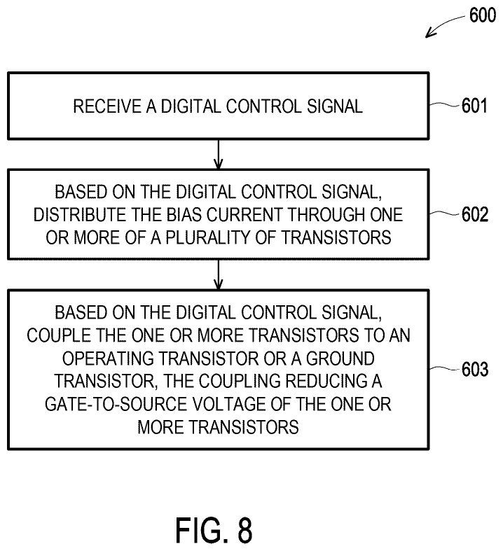

FIG. 8 depicts a method of reducing gate leakage current, in accordance with some embodiments. In the example shown in FIG. 8, the method 600 includes a first step 601 of receiving a digital control signal. The method 600 further includes a second step 602 of distributing the bias current through one or more of a plurality of transistors based on the digital control signal. The method 600 further includes a third step 603 of coupling the one or more transistors to an operating transistor or a ground transistor based on the digital control signal. The coupling reduces a gate-to-source voltage of the one or more transistors.

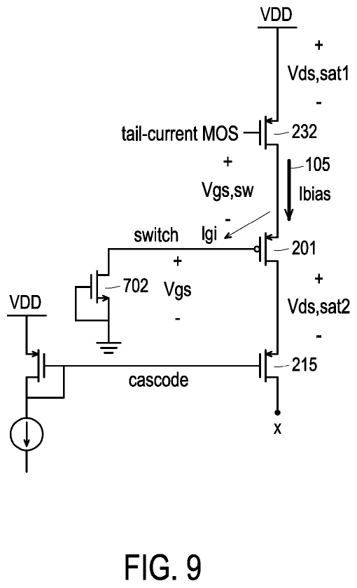

Leakage reduction circuits, as described herein may take a variety of forms. FIG. 9 depicts an alternative implementation of a leakage reduction circuit applied to the gate of a transistor on a resistive path of a DEM. A bias current 105 is received from the first current matching device 232 of the current mirror 101 at a first transistor 201. The output of that transistor is provided to a first transistor 215 of the cascode stage 104. The gate of the first transistor 201 is controlled by a leakage reduction circuit transistor 702. When the first transistor 201 is selected as active, the leakage reduction circuit transistor 702 pulls node p1 low (as shown in FIG. 9), which allows the bias current to flow from the current mirror transistor 232 to the cascode transistor 215. In this on state, the inversion gate leak (I_{GI}) from the bias current to the grounded nodes of the leakage reduction circuit transistor 702 is limited by a small V_{GS} associated with the first transistor 201. When the first transistor 201 is not selected, a high signal is applied to node p1, turning the first transistor 201 off, preventing the flow of current from the current mirror transistor 232 to the cascode transistor 215. In this instance, gate leak from the high signal at p1 through the first switch 201 is limited (e.g., is substantially less than I_{GI}).

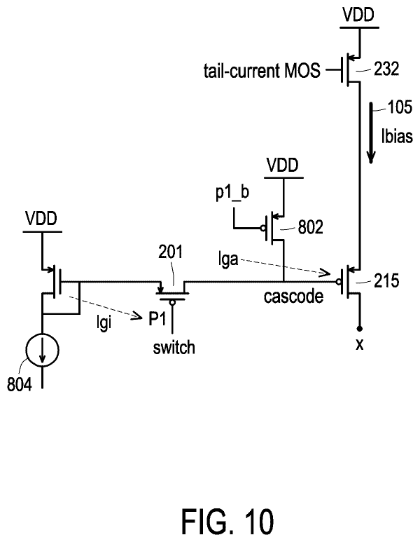

FIG. 10 depicts a second alternative implementation of a leakage reduction circuit applied to the drain/source of the transistor 201 on a resistive path of a DEM. In this instance, the bias current 105 from the first current matching device 232 is directly received by the first transistor 215 of the cascode stage 104. The gate of the first transistor 215 of the cascode stage 104 is controlled by the first transistor 201 and the leakage reduction circuit transistor 802. The leakage reduction current transistor 802 receives the inverse (p1_b) of the control signal applied at node p1, controlling a signal provided to the gate of the cascode transistor 215. When a low signal is applied at p1, the first transistor 201 is on, providing a path from 804 to the gate of the cascode transistor 215. This pulls the gate of the cascode transistor 204 low, allowing the bias voltage 105 to traverse that transistor 215. Correspondingly, a high signal is applied at p1_b, turning off leakage reduction circuit transistor 802. When a high signal is applied to the first transistor 201 at p1, a low signal is provided to the gate of the leakage reduction circuit transistor 802, applying a high signal to the gate of the cascode transistor 215, turning it off.

In this example, when the first transistor 201 is on, V_{gs,sw} ˜ (V_{DD}−V_{dsat(current_mirror_transistor)})−V_{gs,cascode}, where the switch gate leak is not on the bias current path. When the first transistor 201 is off, the cascode-gate is tied to VDD. As depicted in the following figure, a similar implementation can be applied directly to a current mirror transistor.

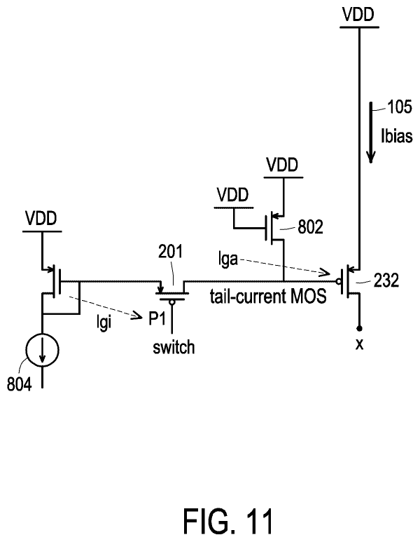

FIG. 11 depicts a further example of the leakage reduction circuit of FIG. 10 in an implementation where no cascode stage is utilized. Here, the gate of the first current matching device 232 of the current mirror circuit 101 is controlled directly. A low signal at p1 turns the first transistor 201, such that a path from 804 to the to the gate of the current mirror transistor 232 is present. This pulls the gate of the current mirror transistor 232 low, allowing the bias voltage 105 to traverse that transistor 232. When a high signal is applied to the first transistor 201 at p1, a high signal from the leakage reduction circuit transistor 802 is applied, turning the current mirror transistor 223 off.

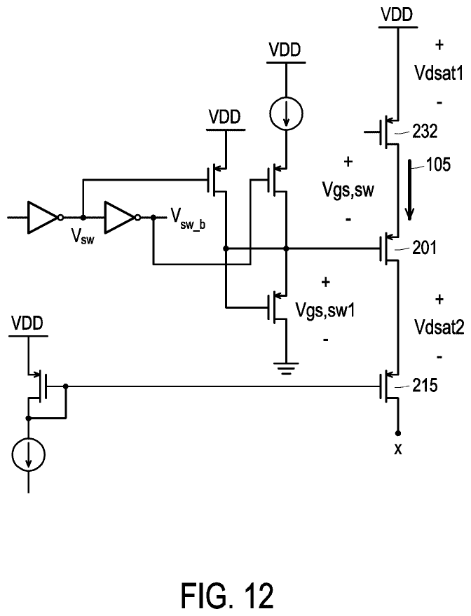

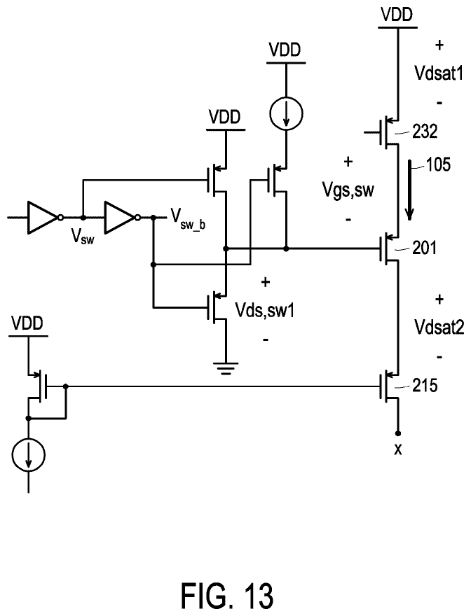

FIG. 12 provides a further alternative for control of the gate of the first transistor 201 between a current mirror transistor 232 and a cascode transistor 215. There, when the first transistor 201 is on, V_{gs,sw} ˜ (V_{DD}−V_{dsat(current_mirror_transistor)})−V_{gs,sw1}. When the switch is off, the gate of the cascode transistor 215 is tied to VDD. FIG. 13 provides an additional alternative for control of the gate of the first transistor between the current mirror transistor 232 and the cascode transistor 215. There, when the switch is on, V_{gs,sw} ˜ (V_{DD}−V_{dsat(current_mirror_transistor)})−V_{gs,sw1}. And again, when the switch is off, the gate of the cascode transistor 215 is tied to V_{DD}.

Systems and methods are described herein. In one example, a circuit comprises an operating voltage node, a current mirror circuit, and a dynamic element matching (DEM) circuit. The current mirror circuit is coupled to the operating voltage node and comprises a plurality of resistive devices. The current mirror circuit is configured to generate a bias current over the plurality of resistive devices. The DEM circuit comprises a plurality of DEM transistors coupled to the current mirror circuit. The DEM circuit is configured to switch the bias current through one or more of the plurality of DEM transistors. The DEM circuit includes a leakage reduction circuit configured to reduce a gate current of the one or more of the plurality of DEM transistors and is configured to generate a DEM output current based on the bias current and the gate current.

In another example, a dynamic element matching (DEM) circuit comprises a plurality of DEM transistors. The DEM circuit is configured to receive a bias current and to selectively distribute the bias current using one or more of the plurality of DEM transistors based on a digital control signal. The DEM circuit further includes a leakage reduction circuit coupled to the plurality of DEM transistors. The leakage reduction circuit is configured to reduce a gate-to-source voltage of the one or more of the plurality of DEM transistors.

In another example, a method of reducing gate leakage current comprises receiving a digital control signal. The method further includes distributing a bias current through one or more of a plurality of transistors based on the digital control signal. The method further includes coupling the one or more transistors to an operating transistor or a ground transistor based on the digital control signal. The coupling reduces a gate-to-source voltage of the one or more transistors.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A circuit comprising:
an operating voltage node;
a current mirror circuit coupled to the operating voltage node, the current mirror circuit comprising a plurality of resistive devices, the current mirror circuit configured to generate a bias current over the plurality of resistive devices; and
a dynamic element matching (DEM) circuit comprising a plurality of DEM transistors coupled to the current mirror circuit, the DEM circuit configured to switch the bias current through one or more of the plurality of DEM transistors, the DEM circuit including a leakage reduction circuit configured to reduce a gate current of the one or more of the plurality of DEM transistors, the DEM circuit configured to generate a DEM output current based on the bias current and the gate current.

2. The circuit of claim 1, further comprising a cascode stage coupled to the DEM circuit, the cascode stage including a plurality of cascode transistors configured to receive the DEM output current and to generate a cascode stage output current.

3. The circuit of claim 2, further comprising a chopper circuit coupled to the cascode stage, the chopper circuit configured to receive the cascode stage output current and to operate a chopper switch based on the cascode stage output signal.

4. The circuit of claim 1, wherein the DEM circuit includes a plurality of current branches, each of the current branches comprising the plurality of DEM transistors.

5. The circuit of claim 1, wherein the leakage reduction circuit includes an operating transistor and a ground transistor coupled to each of the DEM transistors.

6. The circuit of claim 1, wherein the leakage reduction circuit reduces the gate current of the one or more DEM transistors by reducing a gate-to-source voltage of the one or more DEM transistors.

7. The circuit of claim 1, wherein the leakage reduction circuit is configured to form a stacked gate structure including the one or more DEM transistors.

8. The circuit of claim 1, wherein the resistive devices are current mirror transistors.

9. A dynamic element matching (DEM) circuit comprising:
a plurality of DEM transistors, the DEM circuit configured to receive a bias current and to selectively distribute the bias current using one or more of the plurality of DEM transistors based on a digital control signal; and
a leakage reduction circuit coupled to the plurality of DEM transistors, the leakage reduction circuit configured to reduce a gate-to-source voltage of the one or more of the plurality of DEM transistors.

10. The DEM circuit of claim 9, wherein the leakage reduction circuit is further configured to form a stacked gate structure including the one or more of the plurality of DEM transistors.

11. The DEM circuit of claim 9, wherein the leakage reduction circuit includes a separate operating transistor coupled to each of the plurality of DEM transistors.

12. The DEM circuit of claim 11, wherein the leakage reduction circuit includes a separate ground transistor coupled to each of the plurality of DEM transistors.

13. The DEM circuit of claim 12, wherein each of the operating transistors and each of the ground transistors are PMOS transistors.

14. The DEM circuit of claim 9, wherein the DEM circuit includes a plurality of current branches, each of the plurality of current branches including the plurality of DEM transistors.

15. The DEM circuit of claim 14, wherein each of the plurality of current branches is coupled to a current mirror transistor.

16. A method of reducing gate leakage current comprising:
receiving a digital control signal;
based on the digital control signal, distributing a bias current through one or more of a plurality of transistors; and
based on the digital control signal, coupling the one or more transistors to an operating transistor or a ground transistor, the coupling reducing a gate-to-source voltage of the one or more transistors.

17. The method of claim 16, further comprising receiving the bias current and generating a DEM output current based on the bias current and the gate leakage current.

18. The method of claim 16, wherein the operating transistor is a PMOS operating transistor having a gate terminal coupled to an operating voltage node.

19. The method of claim 16, wherein the ground transistor is a PMOS ground transistor having a gate terminal coupled to a ground voltage node.

20. The method of claim 16, wherein the plurality of transistors are included in one of a plurality of current branches.
